(19) United States
(12) Patent Application Publication
(10) Pub. No.: US 2006/0194034 A1
(43) Pub. Date: Aug. 31, 2006

(54) Method for the production of fiber composites and fiber composite produced according to said method

(76) Inventor: Klaus-Kurt Kolzer, Hilden (DE)

Correspondence Address: RANKIN, HILL, PORTER & CLARK, LLP, 925 EUCLID AVENUE, SUITE 700, CLEVELAND, OH, 44115-1405, US

(21) Appl. No.: 10/550,999

(22) PCT Filed: Mar. 18, 2004
(86) PCT No.: PCT/EP04/02789

§ 371 Date: Sep. 26, 2005

(30) Foreign Application Priority Data
Apr. 1, 2003 (DE) 103 14 901.5
Jul. 1, 2003 (DE) 20110 085.9

(51) Int. Cl. B27N 3/04; B27N 3/12; B29C 44/02; B29B 15/10; B32B 27/04

(52) U.S. Cl. 428/297.4; 264/45.4; 264/137; 264/109; 156/296; 428/317.1

(57) ABSTRACT

The invention relates to a method for the production of fiber composites and a fiber composite which is produced according to the method of the invention.

The invention relates to a method for the production of fiber composites. In addition, the invention relates to a fiber composite produced according to the method according to the invention.

It is known to produce composites by spraying endless strands, preferably glass-fiber strands, together with hardenable, thermosetting resins onto a substrate and letting the whole thing harden. To this end, glass-fiber strands are used mainly, which are taken out of a bundle of hundreds of elementary fibers and cut to predefined lengths, for example of 1 to 10 cm, by means of a cutter and at the same time are wet with a resin matrix at a certain weight ratio, for example 30% glass fibers and 70% resin. These glass fiber strands are very thin, namely a few tenths of a millimeter, and can be laid in a flat, two-dimensional random layer, due to their ratios of length and thickness.

Voluminized fibers within the sense of the invention are known from DE 10114708 A1, as well as from EP 0 222 399 B1.

The invention is based on the object of producing three-dimensional fiber composites having a particularly large volume and which, if required, contain openings and/or cavities that can be permeable to air and liquids.

According to the invention, this object is achieved with a method having the features of claim 1. Advantageous embodiments and developments of this method are the subject matter of the subclaims referring to claim 1.

Furthermore, the above-mentioned object is achieved with a fiber composite having the features of claim 10. Advantageous embodiments and developments of this fiber composite are the subject matter of the subclaims referring to claim 10.

According to the invention, a staple fiber mat, for example, can be produced which contains glass strands that preferably have been modified to voluminize the mat formed of strands by means of expandable thermoplastic hollow microspheres. This voluminization or increase of volume takes place by embedding non-expanded thermoplastic microparticles such as hollow microspheres, which contain a certain amount of inflating gas, for example butane, in the interstices between the elementary fibers and then expanding them by means of a thermal process.

In this expansion process, the elementary fibers of the bundle of fibers are forced apart from one another, whereby the diameter and the volume of the fiber bundle and/or of the formation consisting of staple fibers increases by at least ten times to a hundred times. The fiber strands or other formations thus voluminized can be processed by means of an apparatus that is also suitable for the production of sprayed fiber laminates.

During the cutting of such fiber bundles, beam-like crude fiber stables are the result which, in contrast to the thin, non-voluminized fibers, align themselves not in two but rather in three dimensions and which form a voluminous mat with a very open, air-permeable structure. By means of suitable binding agents that are necessary anyway for fixing the microparticles, for example microspheres, it is furthermore possible to give the fiber composites a certain stiffness which supports the maintenance of the open structure until the resin material has hardened.

By adjusting the spraying nozzle, the amount of synthetic resin used in the spraying process can be set so that it is just sufficient to fill the open-pore and absorbent formations of staple fibers with resin to saturation, while cavities still remaining between the individual staple fibers stay open. This results in the additional effect that the hollow microspheres embedded between the staple fibers reduce the resin uptake (in relation to the volume) by up to 50% to 60%, compared to non-volumized fiber formations. Apart from saving weight in a considerable extent, it is possible to save costs in an equally considerable amount.

The resin fiber spraying method may have been known for 40 years and is used, in particular, to produce a glass-fiber reinforced plastic laminate. Surprisingly, it was established that this known spraying method can also be applied to voluminized fibers. The person skilled in the art did not expect that the comparably very light fibers can be thrown across the required distances of typically 0.5 to 2 meters in order to reach the target, i.e. a female mold. The person skilled in the art would have expected that a female mold having a size of typically 30 to 40 cm would largely be missed due to the lightness of the voluminized fibers, and that thus, the waste would becom too large. Furthermore, a lumping of the voluminized fibers hitting the female mold was to be expected.

Instead, the very light and soft material, i.e. the voluminized fibers, do not mat together. Surprisingly, the cutting device (cutter) used to chop endless threads and/or fiber bundles is not clogged, which otherwise would have led to a great maintenance effort.

In the processing of glass fibers known from the state of the art, static charging constitutes a big problem. Therefore, countermeasures such as grounding and ventilation must be taken in the processing of glass fibers. Therefore, the person skilled in the art would have expected that problems relating to static charging would be all the bigger in the processing of voluminized fibers according to the invention which consist of plastics. Surprisingly, however, this was not the case.

These above-mentioned problems feared by the skilled person could be avoided, in particular, by sufficient wetting of the voluminized fibers with resin particles. In this case, the kinetics are not determined by the voluminized fibers but rather by the significantly heavier resin. The uniform distribution of the sprayed voluminized fibers on the female molds could thus be realized. A distance of 2 meters could be bridged without problem during spraying. Small female molds were also hit with sufficient accuracy so that overly large amounts of waste and pollution connected therewith could be avoided.

By generating pressure in a press or by means of hand rollers, for example, a three-dimensional mat produced in this way or the like can be compressed, at least in places, to so that a homogeneous laminate that is free of air bubbles results in which the originally three-dimensionally arranged staple fibers have aligned in a two-dimensional random layer. If, however, the material is left to harden without the application of pressure after spraying on the fiber mat, a three-dimensional mat with an open structure will be the result.

Depending on contructional requirements, the processing person can vary at will the density of this structure by application of more or less pressure. It is also possible to produce areas with a flat, homogeneous structure and areas with a very voluminous structure by means of localized pressure within a molded article or formation produced in this manner. The material thicknesses can vary up to threefold between a three-dimensional mat hardened without pressure and a compressed mat.

Particularly interesting is the possibility of the production of sandwich structures wherein a first base cover layer is produced from a homogeneous ply of glass fibers lying flat, onto which a core ply of a three-dimensional random layer of voluminzed staple fibers is laid. The final cover layer in turn is a smooth layer of two-dimensionally aligned staple fibers.

This technology can be applied in one working step, the wet-in-wet production resulting in a total homogeneity of the sandwich structure that cannot be achieved with the production method of usual sandwich structures, by embedding light but foreign materials, for example wood or foamed plastic. The entire sandwich structure then consists of cut staple fibers that hook into each other at the boundary surfaces. Cover layers that can consist of glass fiber material are therefore not bonded with the core material. Thus, a novel product with superior technical properties results. In comparison to the sandwich structures in which cover layers were bonded with a middle ply, it was possible to improve the shear strength, the flexural rigidity as well as the elastic modulus at the same material thicknesses and weights of cover layers and core material. Increases in the above mentioned technical parameters by 20% to 30% were effected.

The costs of production were also significantly lowered, because one gluing step can be omitted and cover plies and core material are produced in one working step. Glass fibers, for example, are therefore sprayed for the production of cover plies. The core material is generated by spraying the voluminised fibers.

Sandwich structures produced in an open system in this manner have a extremely low specific weight and are of the highest dimensional stability, in particular with respect to flexural rigidity and shearing strength.

According to the invention, fenders for an automobile, bumpers, spoilers, air deflectors, motor covers for electric motors, deck hatches for a boat, floor tiles, panels, children's toys such as slides as well as gardening tools are produced in particular. These are typical small parts or small molds.

### EXAMPLE

Strands of glass fibers that have been voluminized by embedding thermoplastic hollow microbodies are sprayed onto a female mold by means of a resin-fiber-spraying gun. Here, the endless strands are simultaneously chopped into staple fibers of, for example, 3 cm length by means of a cutter and sprayed onto the female mold together with a directed spray of hardenable resin such as unsaturated polyester. The amount of resin used is set so that it is just sufficient for the saturation of the absorbent staple fibers. The proportion of resin amounts to about 50% in relation to the fiber volume.

The expanded staple fibers have a beam-like and voluminous structure so that a mat layer thus resulting aligns in a three-dimensional arrangement of the stable fibers. The synthetic resin sprayed out simultaneously is absorbed by the porous staple fibers, with cavities located between the staple fibers remaining open and air-permeable. After the resin has hardened, the result is a composite of extremely hard staple fibers aligned three-dimensionally which yield a composite material which is both light and has great static strength that is comparable at the contact and crossing points with so-called chevaux de frise.

A composite produced in this manner can also be used as a core layer of a sandwich structure by covering this composite with two external cover plies of non-voluminized thin fiber composites. In these cover layers, the necessary amount of resin in relation to the fiber volume is about 95%. The thicknesses of the individual layers depend on the desired constructional requirements.

Due to the production of the sandwich structure which is possible in one working step (wet-in-wet), mechanical strengths can be achieved in relation to the specific weight that can be achieved with almost no other sandwich structure.

Areas of use for such composites are given wherever greatest strengths at the lowest possible weight are desirable, for example, in the production of boats, vehicles, airplanes, fan blades, containers, formwork panels and the like.

For the purpose of further illustration of the invention, an embodiment of the mat-shaped composite is represented schematically in the drawing, wherein

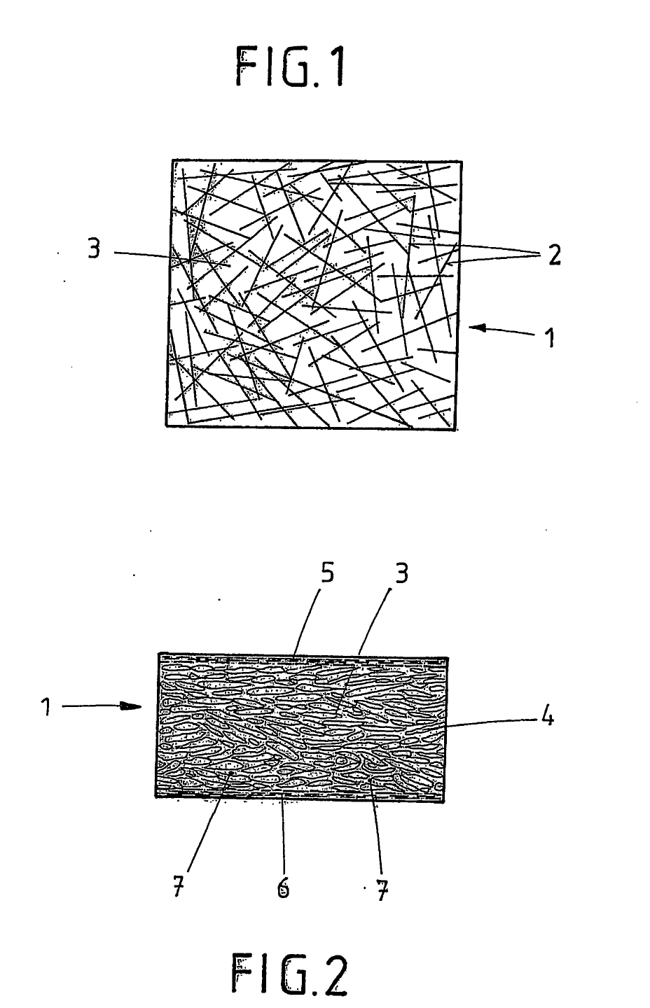

FIG. 1 shows a top view onto a section of the mat-shaped composite

FIG. 2 shows a cross-section of the composite of FIG. 1.

It can be seen from the top view of a mat-shaped composite (1) shown in FIG. 1 that it contains randomly laid staple fibers (2) which are embedded in a matrix (3) of hardenable thermosetting synthetic resin and are thus held together. Between the staple fibers (2), thermoplastic hollow microspheres are embedded which cannot be seen in the drawing that have been expanded under the influence of heat so that the matrix (3) with the staple fibers (2) embedded therein in the form of a random layer form a three-dimensional composite.

The composite (1) is formed in the shape of a sandwich, as FIG. 2 shows. On a three-dimensional core layer (4), a top cover ply (5) and a bottom cover ply (6) are disposed. In contrast to the core layer (4), the cover plies (5) and (6) are formed two-dimensionally, so to speak, since no expandable thermoplastic hollow microspheres or similar microbodies are embedded between the staple fibers of these layers.

FIG. 2 reveals that cavities (7) are contained in the matrix (3) of the core layer (4) that make the mat-shaped composite (1) permeable to air and liquids.

In contrast to the core layer (4), the cover plies (5) and (6) are free of bubbles and therefore formed leakproof, as can be seen from FIG. 2.

By the invention, the production of sandwich molded articles of composite materials that are not produced in the closed system, i.e. by pressing in a mold consisting of two mold halves, but rather in the so-called open system.

1-18. (canceled)

19. Method for the production of fiber composites, wherein staple fibers that are soaked with hardenable thermosetting synthetic resin and cut to length are laid in a three-dimensional random layer and thus are bound together.

20. Method according to claim 19, wherein the staple fibers have a length of 0.5 to 20 cm.

21. Method according to claim 19, wherein the staple fibers comprise glass fibers.

22. Method according to claim 19, wherein the staple fibers comprise plastic.

23. Method according to claim 19, wherein the staple fibers comprise carbon fibers.

24. Method according to claim 19, wherein before or during the laying of the staple fibers, said staple fibers have hollow thermoplastic microspheres embedded therebetween.

25. Method according to claim 24 wherein the hollow thermoplastic microspheres contain an inflating gas, and wherein the hollow thermoplastic microspheres are expanded by heating the inflating gas.

26. Method according to claim 19, wherein the cut staple fibers are wetted with a hardenable synthetic resin selected from the group consisting of unsaturated polyester, epoxy resin, polyurethane resin, vinyl ester resin and phenolic resin in an amount sufficient to saturate the staple fibers, wherein cavities between the three-dimensionally arranged staple fibers remain open.

27. Method according to claim 19, wherein the three-dimensional random layer is provided on at least one side with a smooth, homogeneous, two-dimensional layer of non-volumized fibers.

28. Method according to claim 19, wherein the three-dimensional random layer is at least partially compressed to a homogeneous composite layer that is free of bubbles.

29. Fiber composite consisting of a matrix of hardened thermoplastic synthetic resin and staple fibers embedded therebetween in a random three-dimensional arrangement.

30. Fiber composite according to claim 29, wherein the matrix includes cavities that are gas-permeable liquid-permeable or both.

31. Fiber composite according to claim 29, wherein the matrix contains cut staple fibers having a length of 0.5 to 20 cm.

32. Fiber composite according to claim 31, wherein the staple fibers are selected from the group consisting of glass fibers and carbon fibers.

33. Fiber composite according to claim 29, wherein the cut staple fibers are volumized by embedding hollow thermoplastic microspheres therebetween.

34. Method according to claim 33 wherein the hollow thermoplastic microspheres contain an inflating gas and wherein the hollow thermoplastic microspheres are expanded by heating the inflating gas.

35. Fiber composite according to claim 29, wherein the three-dimensionally arranged staple fibers are wetted with a hardenable synthetic resin selected from the group consisting of unsaturated polyester, epoxy resin, polyurethane resin, vinyl ester resin, and phenolic resin, in an amount sufficient to saturate the absorbent staple fiber bundles, wherein cavities between the three-dimensionally arranged staple fibers remain open.

36. Fiber composite according to claim 29, wherein the cut staple fibers are arranged in the shape of a sandwich structure, wherein a core layer resides between a first cover layer and a second cover layer, wherein the core comprises a three-dimensionally arranged random layer of volumized staple fibers and the first and second cover layers each comprise a smooth, homogeneous, two-dimensionally arranged layer of non-volumized fibers.

38. Fiber composite according to claim 29, wherein a portion of the cut staple fibers, are compressed to a homogeneous composite layer free of air bubbles, and a portion of the cut staple fibers, not processed with pressure, remain randomly arranged in a three-dimensional random layer.

39. Construction component comprising a fiber composite according to claim 29, wherein the construction component is selected from the group consisting of a fender, a bumper, a spoiler, an air deflector, a motor cover for electric motors, a deck hatch, a flap gate, a floor tile, a panel, or a children's toy.
